(19) United States
(12) Patent Application Publication
(10) Pub. No.: US 2026/0147942 A1
(43) Pub. Date: May 28, 2026

(54) MEMS APPARATUS FOR FORMING PHYSICAL UNCLONABLE FUNCTION KEY AND OPERATION METHOD OF MEMS APPARATUS

(71) Applicant: NATIONAL TAIWAN UNIVERSITY, TAIPEI (TW)

(72) Inventors: Wei-Chang LI, TAIPEI (TW); Ting-Yi CHEN, TAIPEI (TW)

(21) Appl. No.: 19/269,065

(22) Filed: Jul. 15, 2025

Related U.S. Application Data
(60) Provisional application No. 63/726,251, filed on Nov. 28, 2024.

(51) Int. Cl. G06F 21/75; B81B 7/00; H03F 3/45; H03H 9/24

(52) U.S. Cl. CPC G06F 21/75; B81B 7/008; H03F 3/45475; H03H 9/2463; B81B 2201/0271; B81B 2203/019; B81B 2203/0307; B81B 2203/04; B81B 2207/03

(57) ABSTRACT

A micro-electro-mechanical system (MEMS) apparatus includes at least one semiconductor device, a power supply, a transimpedance amplifier, a lock-in amplifier, a signal analyzer, and a processor. The semiconductor device has a MEMS structure, an input electrode, and two anchors. The two anchors of the MEMS structure are respectively fixed and could serve as output electrodes, the input electrode is adjacent to a long side of the MEMS structure, and the MEMS structure includes five sections having different widths. The power supply is electrically connected to the input electrode. The transimpedance amplifier is electrically connected to the output electrode. The lock-in amplifier is electrically connected to the transimpedance amplifier and the input electrode. The signal analyzer is electrically connected to the transimpedance amplifier. The processor is electrically connected to the signal analyzer.

### CROSS-REFERENCE TO RELATED APPLICATION

This application claims priority to U.S. Provisional Application Ser. No. 63/726,251, filed Nov. 28, 2024, which is herein incorporated by reference.

### BACKGROUND

### Field of Invention

The present disclosure relates to a micro-electro-mechanical system (MEMS) apparatus for forming a physical unclonable function (PUF) key and an operation method of the MEMS apparatus.

### Description of Related Art

With the proliferation of wireless sensor nodes in the Internet of Things (IoT), the demand for secure communication requires robust authentication protocols which typically implemented through encryption algorithms.

However, traditional key generation and storage approaches that rely on non-volatile memory (NVM) are increasingly vulnerable to side-channel attacks, making secure storage challenging. On the other hand, physical unclonable functions (PUFs) have emerged as a promising alternative for secure communications by eliminating the need for key storage in memory. For example, PUFs generate a unique and unpredictable bit sequence response only when challenged, and thus reducing the risk of key exposure. However, CMOS based PUFs are susceptible to modeling attacks due to relatively limited complexity, and LC based PUFs is available only in one format and lacks scalability for on-chip integration.

### SUMMARY

According to some embodiments of the present disclosure, a micro-electro-mechanical system (MEMS) apparatus includes at least one semiconductor device, a power supply, a transimpedance amplifier, a lock-in amplifier, a signal analyzer, and a processor. The semiconductor device has a MEMS structure, an input electrode, and two anchors. The two anchors of the MEMS structure are respectively fixed and could serve as output electrodes. The input electrode is adjacent to a long side of the MEMS structure, and the MEMS structure includes five sections having different widths. The power supply is electrically connected to the input electrode. The transimpedance amplifier is electrically connected to the output electrode. The lock-in amplifier is electrically connected to the transimpedance amplifier and the input electrode, and is configured to generate an AC voltage to the input electrode and backward sweep frequencies of the AC voltage to form a signal drop within a bandwidth. The signal analyzer is electrically connected to the transimpedance amplifier. When a driving frequency of the AC voltage in the bandwidth is applied to the input electrode to drive the MEMS structure, the signal analyzer is configured to form a frequency comb signal based on a beating waveform of the MEMS structure. The processor is electrically connected to the signal analyzer and configured to define an amplitude range based on output power amplitudes of peaks of the frequency comb signal and digitalize an amplitude of each of the peaks of the frequency comb signal based on the amplitude range.

In some embodiments, the five sections include a first section, a second section, a third section, a fourth section, and a fifth section that are connected in sequence, the second section is wider than the first section, the third section, and the fifth section, and the fourth section is wider than the second section.

In some embodiments, the third section is wider than the first section and the fifth section.

In some embodiments, the first section is longer than the fourth section, and the fourth section is longer than the second section, the third section, and the fifth section.

In some embodiments, the second section is longer than the third section, and the third section is longer than the fifth section.

In some embodiments, the MEMS structure has two convex portions and three concave portions, and each of the two convex portions is located between two of the three concave portions.

In some embodiments, when the driving frequency of the AC voltage in the bandwidth is applied to the input electrode to drive the MEMS structure, the MEMS structure is configured to form resonance vibrations of the first and the third in-plane flexural modes to trigger an internal resonance at a 1:6 frequency ratio.

In some embodiments, the bandwidth corresponds to an energy transfer region between the first and the third in-plane flexural modes of the MEMS structure.

In some embodiments, the bandwidth is in a range from 1.338 MHz to 1.349 MHz.

In some embodiments, the peaks of the frequency comb signal are top eight highest peaks of the frequency comb signal, and the processor is configured to define the amplitude range based on output power amplitudes of the top eight highest peaks of the frequency comb signal.

In some embodiments, the processor is configured to divide the amplitude range into 2¹⁶ equal intervals to digitalize the amplitude of each of the top eight highest peaks of the frequency comb signal into a 16-bit stream.

In some embodiments, the processor is configured to arrange the 16-bit streams of the top eight highest peaks in a horizontal direction to form a 128-bit physical unclonable function (PUF) key of the MEMS structure of the semiconductor device.

In some embodiments, the MEMS apparatus includes a plurality of the semiconductor devices, wherein the processor is configured to arrange the 128-bit PUF keys of the MEMS structures of the semiconductor devices in a vertical direction.

In some embodiments, the power supply is configured to provide a bias DC voltage to the input electrode.

According to some embodiments of the present disclosure, an operation method of a micro-electro-mechanical system (MEMS) apparatus includes providing at least one semiconductor device having a MEMS structure, an input electrode, and two anchors, wherein the two anchors of the MEMS structure are respectively fixed and could serve as output electrodes, the input electrode is adjacent to a long side of the MEMS structure, and the MEMS structure includes five sections having different widths; generating an AC voltage to the input electrode by a lock-in amplifier; backward sweeping frequencies of the AC voltage to form a signal drop within a bandwidth by the lock-in amplifier; applying a driving frequency of the AC voltage in the bandwidth to the input electrode to drive the MEMS structure; when applying the driving frequency of the AC voltage in the bandwidth to the input electrode to drive the MEMS structure, forming a frequency comb signal by a signal analyzer based on a beating waveform of the MEMS structure; defining an amplitude range by a processor based on output power amplitudes of peaks of the frequency comb signal; and digitalizing an amplitude of each of the peaks of the frequency comb signal by the processor based on the amplitude range.

In some embodiments, the operation method of the MEMS apparatus further includes when applying the driving frequency of the AC voltage in the bandwidth to the input electrode to drive the MEMS structure, forming resonance vibrations of the first and the third in-plane flexural modes of the MEMS structure to trigger an internal resonance at a 1:6 frequency ratio.

In some embodiments, backward sweeping frequencies of the AC voltage to form the signal drop within the bandwidth by the lock-in amplifier is performed such that the bandwidth corresponds to an energy transfer region between the first and third in-plane flexural modes of the MEMS structure.

In some embodiments, the operation method of the MEMS apparatus further includes selecting the peaks of the frequency comb signal to be top eight highest peaks of the frequency comb signal by the processor.

In some embodiments, defining the amplitude range by the processor based on the output power amplitudes of the peaks of the frequency comb signal includes defining the amplitude range by the processor based on the output power amplitudes of the top eight highest peaks of the frequency comb signal.

In some embodiments, digitalizing the amplitude of each of the peaks of the frequency comb signal by the processor based on the amplitude range includes dividing the amplitude range into 2¹⁶ equal intervals by the processor; and digitalizing the amplitude of each of the top eight highest peaks of the frequency comb signal into a 16-bit stream by the processor.

In the aforementioned embodiments of the present disclosure, since the two anchors of the MEMS structure are respectively fixed and could serve as output electrodes, and the MEMS structure has the long side adjacent to the input electrode and includes the five sections having different widths, the MEMS structure can act as a resonator and allow tuning of the resonance frequencies of the resonator's first and third in-plane flexural modes to trigger internal resonance at a 1:6 frequency ratio. The lock-in amplifier can backward sweep the frequencies of the AC voltage such that a signal drop within a bandwidth is formed, and thus a driving frequency of the AC voltage in the bandwidth can be applied to the input electrode to drive the MEMS structure to induce the internal resonance. As a result, the frequency comb signal can be formed by the signal analyzer based on the beating waveform of the MEMS structure, and the processor can digitalize the amplitude of each of the peaks of the frequency comb signal, such that a physical unclonable function (PUF) key can be formed. The PUF key is a unique and unpredictable bit sequence response only when challenged, and thus reducing the risk of key exposure. The semiconductor device having the MEMS structure based PUFs is not susceptible to modeling attacks due to relatively complexity, and can overcome the problems of single format and lacking scalability for on-chip integration.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a top view of a semiconductor device according to one embodiment of the present disclosure.

FIG. 2 is a perspective view of a MEMS structure, a fixing electrode, and two anchors of the semiconductor device of FIG. 1.

FIG. 3 is a schematic view of a MEMS apparatus for forming a physical unclonable function (PUF) key according to one embodiment of the present disclosure.

FIG. 4 is a block diagram of the MEMS apparatus of FIG. 3, in which a signal analyzer is electrically connected to a processor.

FIG. 5 is an illustration of the Amplitude-Frequency relationship chart when a lock-in amplifier of FIG. 3 backward sweeps frequencies of an AC voltage.

FIG. 6 shows a vibration of the MEMS structure in a first in-plane flexural mode.

FIG. 7 shows a vibration of the MEMS structure in a third in-plane flexural mode.

FIG. 8A is an illustration of the beating waveform of the MEMS structure in the first in-plane flexural mode, in which the beating waveform is in a time domain.

FIG. 8B is an illustration of the frequency comb signal of the MEMS structure in the first in-plane flexural mode, in which the frequency comb signal is in a frequency domain.

FIG. 9A is an illustration of the beating waveform of the MEMS structure in the third in-plane flexural mode, in which the beating waveform is in a time domain.

FIG. 9B is an illustration of the frequency comb signal of the MEMS structure in the third in-plane flexural mode, in which the frequency comb signal is in a frequency domain.

FIG. 10 shows Power-Frequency relationship charts of the frequency comb signals of different semiconductor devices due to process deviations.

FIG. 11 is an illustration of the Amplitude-Frequency relationship chart of the frequency comb signal, in which an amplitude range is defined and an amplitude of each of the peaks of the frequency comb signal is digitalized.

FIG. 12 is a 128-bit PUF key of the MEMS structure of the semiconductor device.

FIG. 13A is a Mean-Bit number relationship chart of varying digitalized bits.

FIG. 13B is a Standard Deviation-Bit number relationship chart of varying digitalized bits.

FIG. 14 is a PUF key including 128-bit PUF keys arranged in a vertical direction.

FIG. 15 shows a Gaussian fitted curve of semiconductor devices having MEMS structures for PUFs.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

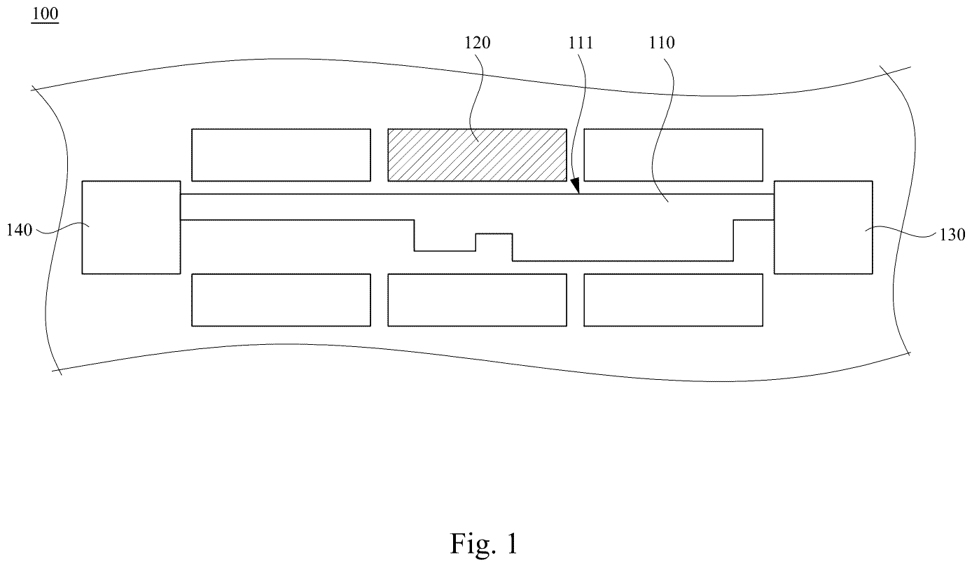

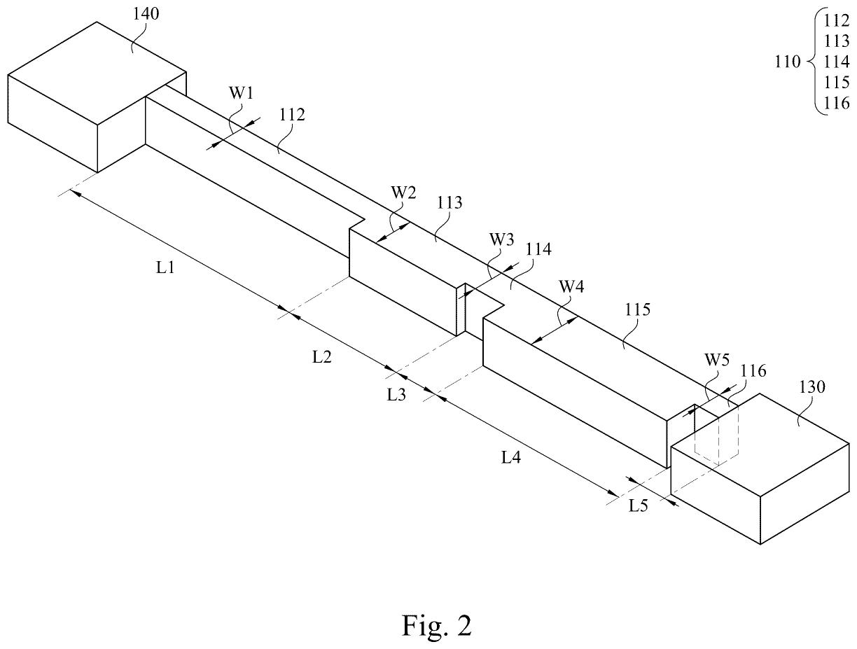

FIG. 1 is a top view of a semiconductor device 100 according to one embodiment of the present disclosure. FIG. 2 is a perspective view of a micro-electro-mechanical system (MEMS) structure 110 and two anchors 130 and 140 that could serve as output electrodes of the semiconductor device 100 of FIG. 1. The semiconductor device 100 is a geometrically nonlinear CMOS-MEMS clamped-clamped beam (CC-beam) resonator. The semiconductor device 100 has the MEMS structure 110, an input electrode 120, and two anchors 130 and 140. The two anchors 130 and 140 of the MEMS structure 110 are respectively fixed and could serve as output electrodes. Furthermore, the input electrode 120 is adjacent to a long side 111 of the MEMS structure 110.

In some embodiments, the MEMS structure 110 includes five sections having different widths W1-W5. For example, the five sections include a first section 112, a second section 113, a third section 114, a fourth section 115, and a fifth section 116 that are connected in sequence. The second section 113 is wider than the first section 112, the third section 114, and the fifth section 116. The fourth section 115 is wider than the second section 113, and the third section 114 is wider than the first section 112 and the fifth section 116. In other words, the MEMS structure 110 has two convex portions (i.e., the second section 113 and the fourth section 115) and three concave portions (i.e., the first section 112, the third section 114, and the fifth section 116), the second section 113 is located between the first section 112 and the third section 114, and the fourth section 115 is located between the third section 114 and the fifth section 116.

In some embodiments, the width W1 of the first section 112 may be 2 μm, the width W2 of the second section 113 may be 4 μm, the width W3 of the third section 114 may be 3 μm, the width W4 of the fourth section 115 may be 5 μm, and the width W5 of the fifth section 116 may be 2 μm. The width W1 may be the same as the width W5.

In addition, the first section 112 is longer than the fourth section 115, and the fourth section 115 is longer than the second section 113, the third section 114, and the fifth section 116. The second section 113 is longer than the third section 114, and the third section 114 is longer than the fifth section 116. In some embodiments, a length L1 of the first section 112 may be 42.9 μm, a length L2 of the second section 113 may be 9.4 μm, a length L3 of the third section 114 may be 8 μm, a length L4 of the fourth section 115 may be 39.7 μm, and a length L5 of the fifth section 116 may be 6 μm.

The MEMS structure 110 can serve as a resonator, and the aforementioned multiple-stepped design for the MEMS structure 110 allows tuning of the resonance frequencies of the resonator's first and third in-plane flexural modes to trigger internal resonance at a 1:6 frequency ratio.

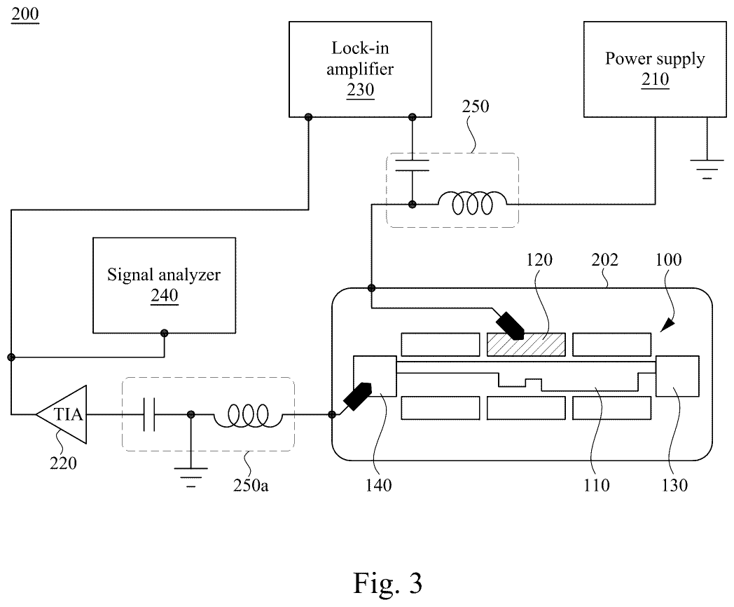

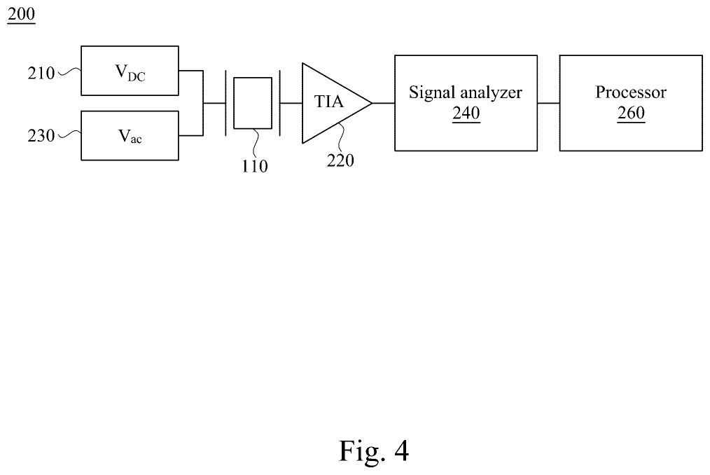

FIG. 3 is a schematic view of a MEMS apparatus 200 for forming a physical unclonable function (PUF) key according to one embodiment of the present disclosure. FIG. 4 is a block diagram of the MEMS apparatus 200 of FIG. 3, in which a signal analyzer 240 is electrically connected to a processor 260. As shown in FIG. 3 and FIG. 4, the MEMS apparatus 200 includes the semiconductor device 100 of FIG. 1, a power supply 210, a transimpedance amplifier (TIA) 220, a lock-in amplifier 230, the signal analyzer 240, and the processor 260. The semiconductor device 100 is located in a vacuum probe station 202. The power supply 210 is electrically connected to the input electrode 120 of the semiconductor device 100 through a bias-tee 250. The transimpedance amplifier 220 is electrically connected to the output electrode (i.e., the anchor 140) of the semiconductor device 100 through another bias-tee 250a. The lock-in amplifier 230 is electrically connected to the transimpedance amplifier 220 and the input electrode 120 of the semiconductor device 100. The signal analyzer 240 is electrically connected to the transimpedance amplifier 220 and the processor 260.

The lock-in amplifier 230 is configured to generate an AC voltage (V_{ac}) to the input electrode 120 of the semiconductor device 100, and the power supply 210 is configured to provide a bias DC voltage (V_{DC}) to the input electrode 120 of the semiconductor device 100.

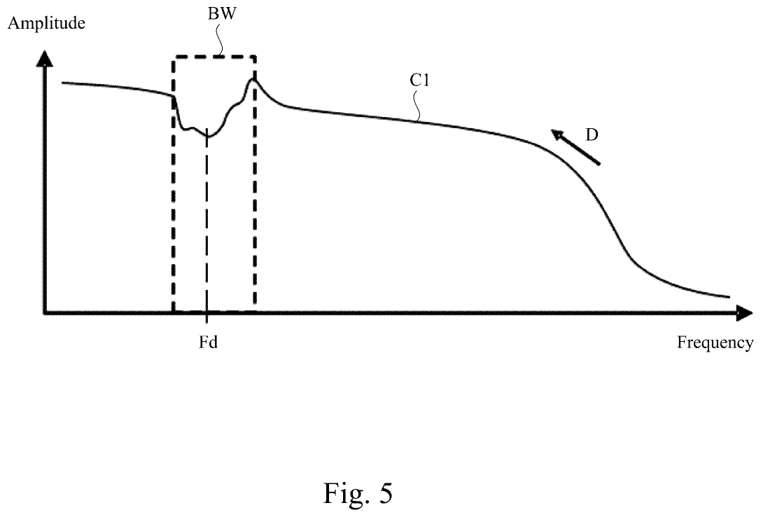

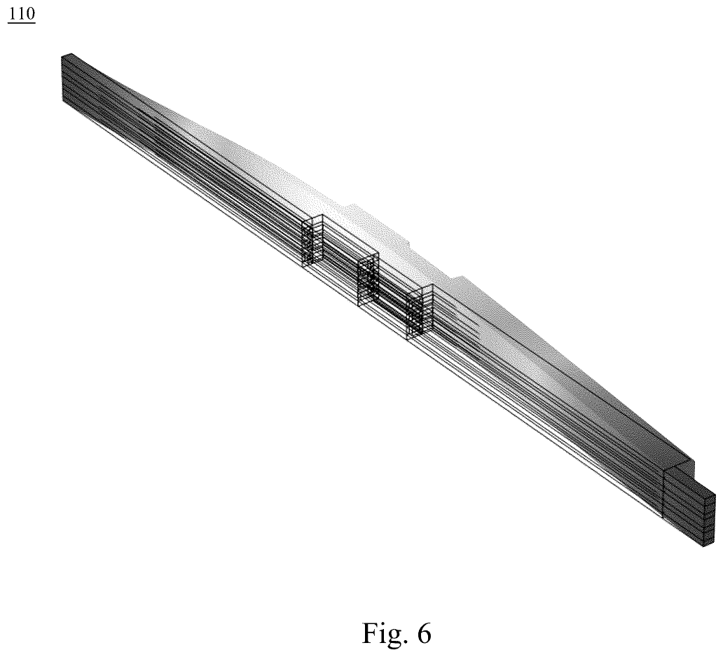

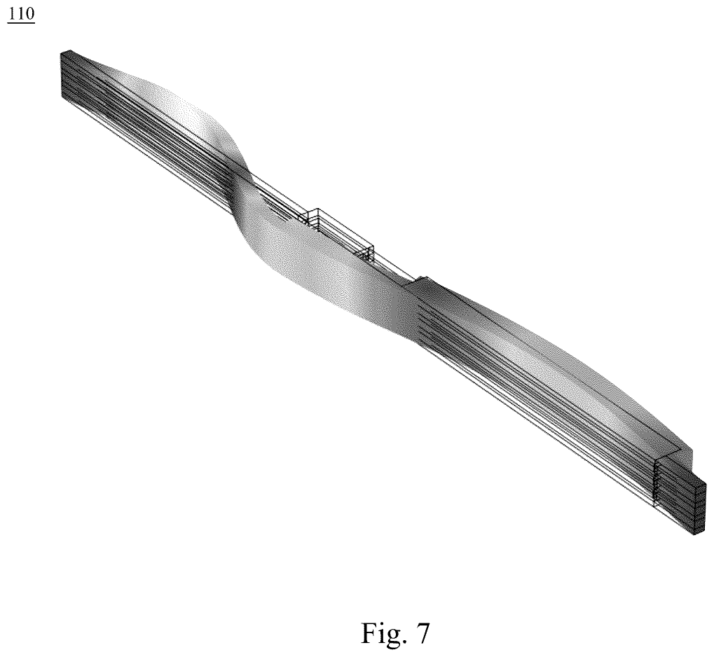

FIG. 5 is an illustration of the Amplitude-Frequency relationship chart when the lock-in amplifier 230 of FIG. 3 backward sweeps frequencies of an AC voltage. As shown in FIG. 3 and FIG. 5, the MEMS structure 110 (i.e., the resonator) can be actuated with the input electrode 120 by the bias DC voltage of the power supply 210 and the AC voltage of the lock-in amplifier 230, and the motion of the MEMS structure 110 can be obtained by the signal analyzer 240 through the transimpedance amplifier 220. The lock-in amplifier 230 backward sweep frequencies of the AC voltage to form a signal drop of a curve C1 within a specific bandwidth BW, and the bandwidth BW corresponds to an energy transfer region between the first and third in-plane flexural modes of the MEMS structure 110, such as the vibration of the MEMS structure 110 in the first in-plane flexural mode of FIG. 6 and in the third coupled mode of FIG. 7. The bandwidth BW is in a range from 1.338 MHz to 1.349 MHz. By applying the backward frequency sweep of the AC voltage around the first in-plane flexural mode (i.e., the first driving mode shown in FIG. 6), the resonator (i.e., the MEMS structure 110) enters an internal resonance region (i.e., the bandwidth BW).

A driving frequency Fd of the AC voltage in the bandwidth BW can be applied to the input electrode 120 to drive the MEMS structure 110. In some embodiments, the driving frequency Fd may be 1.348 MHz. When the driving frequency Fd of the AC voltage in the bandwidth BW is applied to the input electrode 120 to drive the MEMS structure 110, the MEMS structure 110 is configured to form resonance vibrations of the first and the third in-plane flexural modes to trigger an internal resonance at a 1:6 frequency ratio.

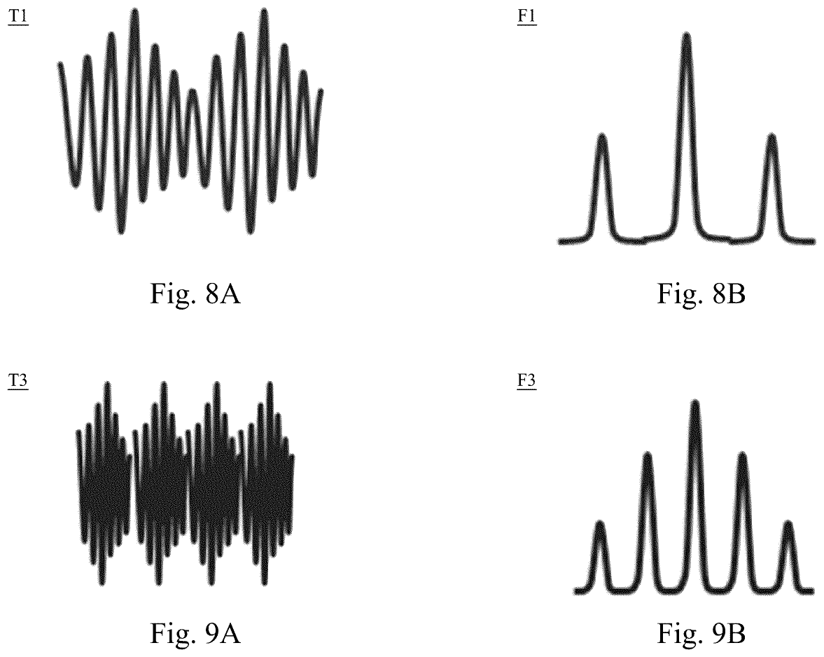

FIG. 8A is an illustration of the beating waveform T1 of the MEMS structure 110 in the first in-plane flexural mode, in which the beating waveform T1 is in a time domain. FIG. 8B is an illustration of the frequency comb signal F1 of the MEMS structure 110 in the first in-plane flexural mode, in which the frequency comb signal F1 is in a frequency domain. The signal analyzer 240 (see FIG. 3) performs a fast Fourier transform (FFT) to form the frequency comb signal F1 based on the beating waveform T1 of the MEMS structure 110.

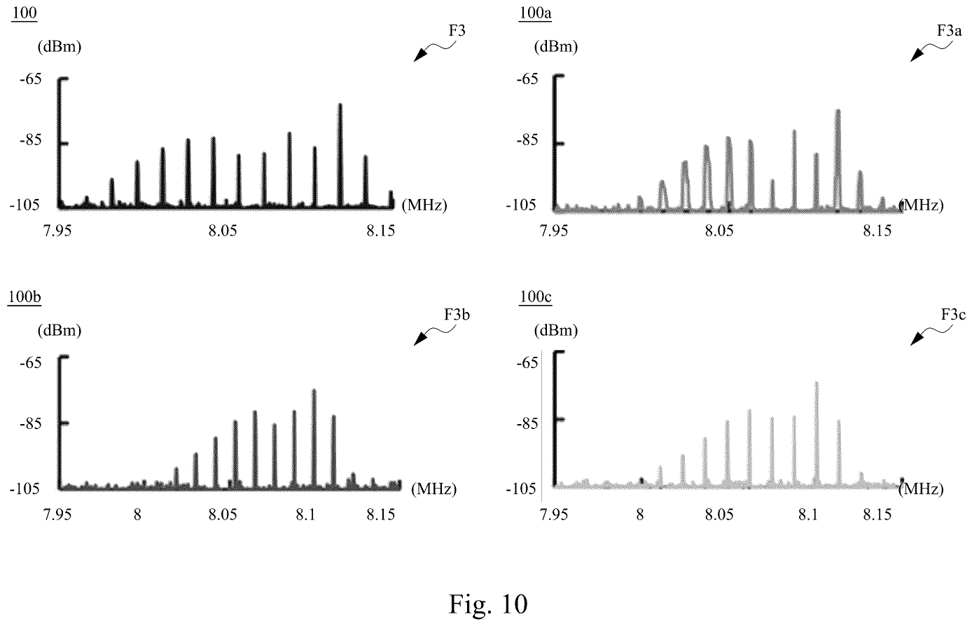

FIG. 9A is an illustration of the beating waveform T3 of the MEMS structure in the third in-plane flexural mode, in which the beating waveform T3 is in a time domain. FIG. 9B is an illustration of the frequency comb signal F3 of the MEMS structure in the third in-plane flexural mode, in which the frequency comb signal F3 is in a frequency domain. The signal analyzer 240 (see FIG. 3) performs a fast Fourier transform (FFT) to form the frequency comb signal F3 based on the beating waveform T3 of the MEMS structure 110. The ratio of the frequency of FIG. 8A (or FIG. 8B) to the frequency of FIG. 9A (or FIG. 9B) is 1:6.

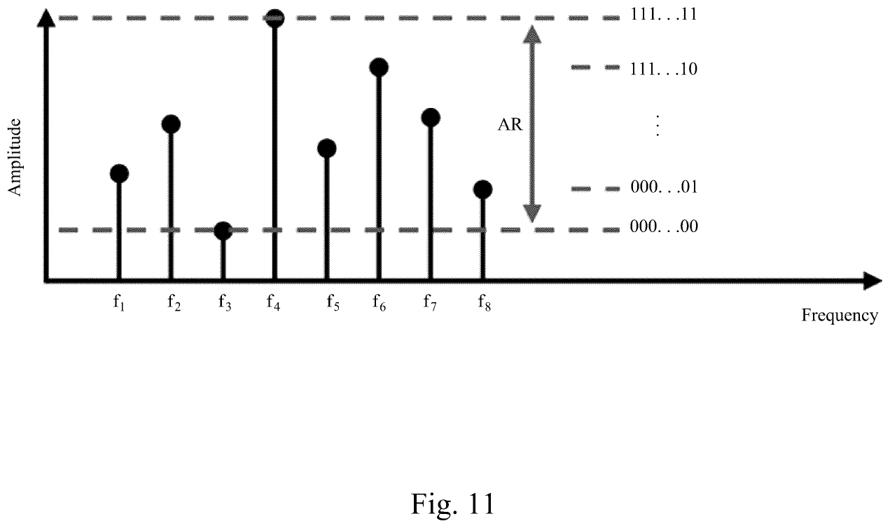

FIG. 10 shows Power-Frequency relationship charts of the frequency comb signals F3, F3a, F3b, and FIG. 3c of different semiconductor devices 100, 100a, 100b, and 100c due to process deviations. The material of the MEMS structure 110 (see FIG. 1) is metal, such as copper. The MEMS structure 110 may be formed by an etching process. However, the etching process performs on different semiconductor devices 100, 100a, 100b, and 100c may induce process deviations for the corresponding MEMS structures 110. As a result, the frequency comb signals F3, F3a, F3b, and FIG. 3c of the semiconductor devices 100, 100a, 100b, and 100c are different, making them highly suitable for physical unclonable function (PUF) applications. Moreover, the frequency comb signals F3, F3a, F3b, and FIG. 3c observed near the third in-plane flexural mode exhibit asymmetric features, further enhancing their sensitivity to process-induced variations.

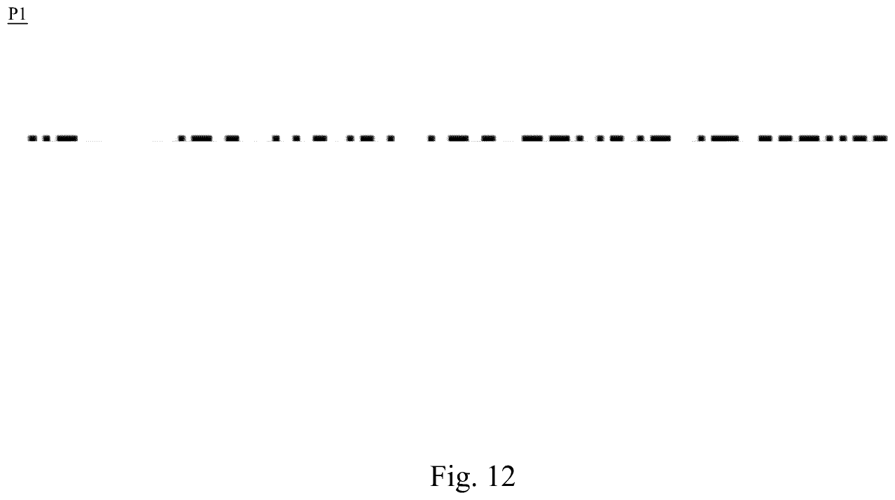

FIG. 11 is an illustration of the Amplitude-Frequency relationship chart of the frequency comb signal, in which an amplitude range AR is defined and an amplitude of each of the peaks of the frequency comb signal F3 is digitalized. Thereafter, the processor 260 (see FIG. 4) electrically connected to the signal analyzer 240 (see FIGS. 3 and 4) defines the amplitude range AR based on output power amplitudes of peaks of the frequency comb signal F3 (see FIG. 10), in which the peaks of the frequency comb signal F3 are top eight highest peaks of the frequency comb signal F3. In other words, the processor 260 is configured to define the amplitude range AR based on the output power amplitudes of the top eight highest peaks of the frequency comb signal F3. The top eight highest peaks of the frequency comb signal F3 are selected by the processor 260, and the top eight highest peaks are arranged in an ascending order from f1 to f8. Moreover, the processor 260 digitalizes the amplitude of each of the peaks of the frequency comb signal F3 based on the amplitude range AR. In some embodiments, the processor 260 may perform analog-to-digital conversion (ADC). The processor 260 is configured to divide the amplitude range AR into 2¹⁶ equal intervals to digitalize the amplitude of each of the top eight highest peaks of the frequency comb signal F3 into a 16-bit stream. For example, the lowest frequency comb signal corresponds to a bitstream of 0000000000000000 and the highest frequency comb signal represents a bitstream of 1111111111111111. In some embodiments, 16-bit stream f1 is 1000011011000011, 16-bit stream f2 is 0001011001100100, 16-bit stream f3 is 1110011110110100, 16-bit stream f4 is 0011010110001110, 16-bit stream f5 is 0010000110011110, 16-bit stream f6 is 1110111001011111, 16-bit stream f7 is 1000111010110011, and 16-bit stream f8 is 1001000111111110.

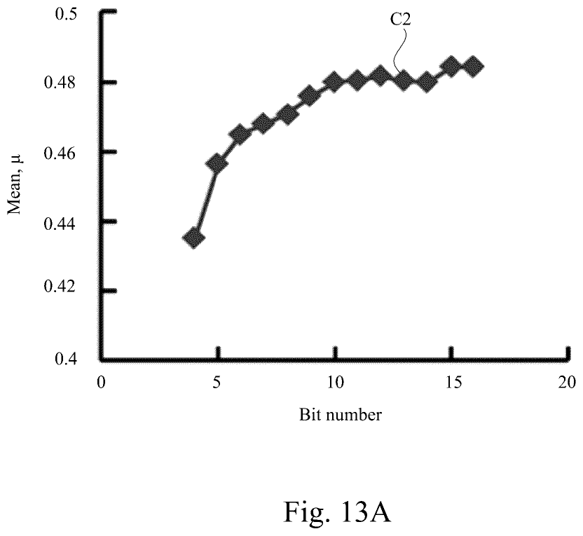

FIG. 12 is a 128-bit PUF key of the MEMS structure 110 of the semiconductor device 100 (see FIG. 1). After forming the aforementioned 16-bit streams f1 to f8, the processor 260 (see FIG. 4) is configured to arrange the 16-bit streams f1 to f8 of the top eight highest peaks in a horizontal direction (i.e.,100001101100001100010110011001001110011110110100001101011000 111000100001100111101110111001011111100011101011001110010001111 11110) to form a 128-bit physical unclonable function (PUF) key P1 of the MEMS structure 110 of the semiconductor device 100. The PUF key P1 is a bit map including black and white squares corresponding to bit “1” and bit “0”.

Referring back to FIGS. 1 and 3, since the two anchors 130 and 140 of the MEMS structure 110 are respectively fixed and could serve as output electrodes, and the MEMS structure 110 has the long side 111 adjacent to the input electrode 120 and includes the five sections 112-116 having different widths W1-W5, the MEMS structure 110 can act as a resonator and allow tuning of the resonance frequencies of the resonator's first and third in-plane flexural modes (see FIGS. 6 and 7) to trigger internal resonance at a 1:6 frequency ratio (see FIGS. 8A to 9B). The lock-in amplifier 230 can backward sweep the frequencies of the AC voltage such that a signal drop within the bandwidth BW (see FIG. 5) is formed, and thus a driving frequency of the AC voltage in the bandwidth BW can be applied to the input electrode to drive the MEMS structure 110 to induce the internal resonance. As a result, the frequency comb signal F3 (see FIG. 10) can be formed by the signal analyzer 240 based on the beating waveform of the MEMS structure 110, and the processor 260 (see FIG. 4) can digitalize the amplitude AR (see FIG. 11) of each of the peaks of the frequency comb signal F3, such that the physical unclonable function (PUF) key P1 (see FIG. 12) can be formed. The PUF key P1 is a unique and unpredictable bit sequence response only when challenged, and thus reducing the risk of key exposure. The semiconductor device 100 having the MEMS structure 110 based PUFs is not susceptible to modeling attacks due to relatively complexity, and can overcome the problems of single format and lacking scalability for on-chip integration.

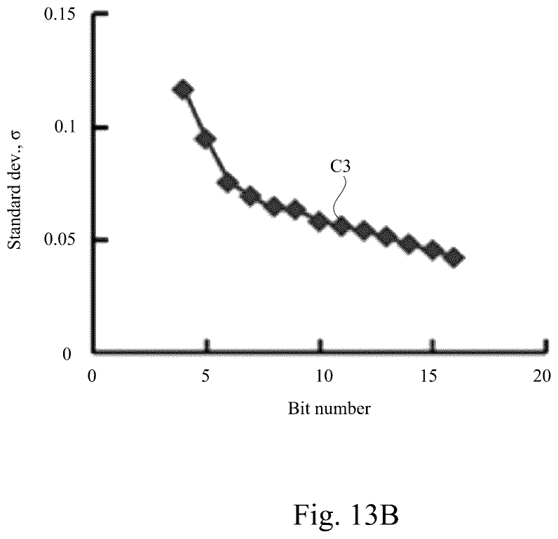

FIG. 13A is a Mean-Bit number relationship chart of varying digitalized bits. FIG. 13B is a Standard Deviation-Bit number relationship chart of varying digitalized bits. Curves C2 and C3 of FIGS. 13A and 13B shows how the number of digitized bits affects the PUF performance by analyzing the fitted Gaussian distribution parameters—mean (μ) and standard deviation (σ). As the bit number increases, μ approaches 0.5 and σ decreases, indicating an improvement in the PUF quality. Accordingly, the aforementioned 16-bit streams are selected for the PUF quality.

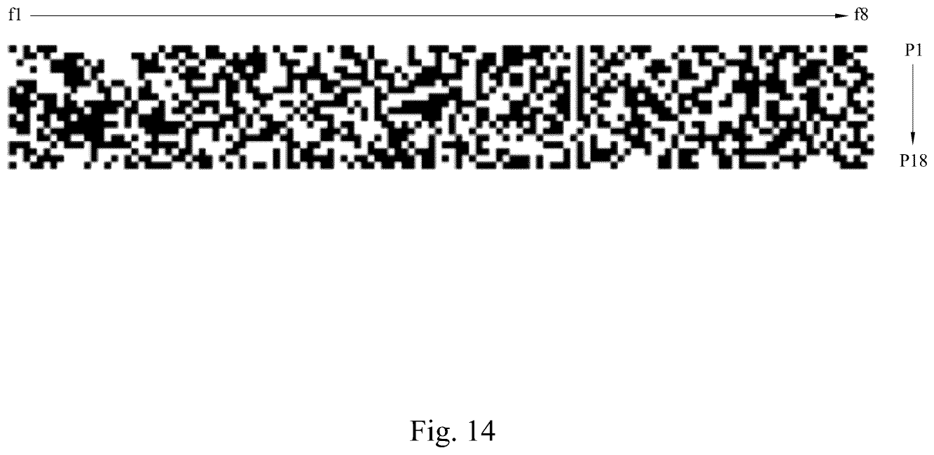

FIG. 14 is a PUF key including 128-bit PUF keys P1 to P18 arranged in a vertical direction. As shown in FIG. 3 and FIG. 14, in some embodiments, the MEMS apparatus 200 includes a plurality of the semiconductor devices 100, and the processor 260 (see FIG. 4) is configured to arrange the 128-bit PUF keys of the MEMS structures 110 of the semiconductor devices 100 in the vertical direction. For example, there are 18 semiconductor devices 100 including 18 MEMS structures 110, and the processor 260 arranges 18 128-bit PUF keys P1 to P18 of the 18 MEMS structures 110 in the vertical direction. Moreover, the PUF key P1 of FIG. 12 is in the first row of FIG. 14.

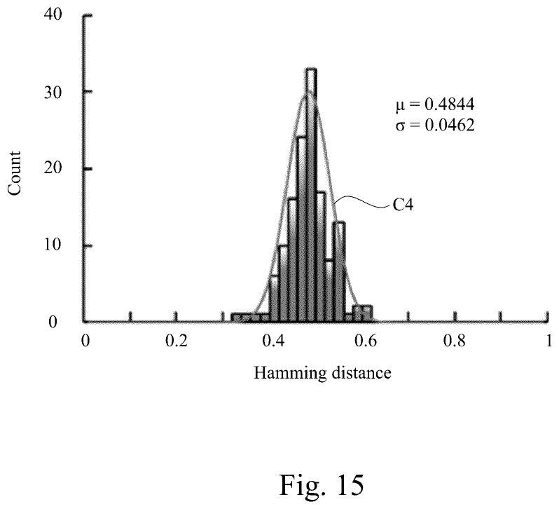

FIG. 15 shows a Gaussian fitted curve C4 of semiconductor devices 100 having MEMS structures 110 (see FIG. 1) for PUFs. There are 18 semiconductor devices 100 including 18 MEMS structures 110. The mean (μ) values are approximately 0.5 and the standard deviation (σ) values are close to 0. The statistical results confirm the high quality and feasibility of the proposed MEMS PUFs.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A micro-electro-mechanical system (MEMS) apparatus, comprising:
at least one semiconductor device having a MEMS structure, an input electrode, and two anchors, wherein the two anchors of the MEMS structure are respectively fixed and serve as output electrodes, the input electrode is adjacent to a long side of the MEMS structure, and the MEMS structure comprises five sections having different widths;
a power supply electrically connected to the input electrode;
a transimpedance amplifier electrically connected to one of the output electrodes;
a lock-in amplifier electrically connected to the transimpedance amplifier and the input electrode, and configured to generate an AC voltage to the input electrode and backward sweep frequencies of the AC voltage to form a signal drop within a bandwidth;
a signal analyzer electrically connected to the transimpedance amplifier, wherein when a driving frequency of the AC voltage in the bandwidth is applied to the input electrode to drive the MEMS structure, the signal analyzer is configured to form a frequency comb signal based on a beating waveform of the MEMS structure; and
a processor electrically connected to the signal analyzer and configured to define an amplitude range based on output power amplitudes of peaks of the frequency comb signal and digitalize an amplitude of each of the peaks of the frequency comb signal based on the amplitude range.

2. The MEMS apparatus of claim 1, wherein the five sections comprise a first section, a second section, a third section, a fourth section, and a fifth section that are connected in sequence, the second section is wider than the first section, the third section, and the fifth section, and the fourth section is wider than the second section.

3. The MEMS apparatus of claim 2, wherein the third section is wider than the first section and the fifth section.

4. The MEMS apparatus of claim 2, wherein the first section is longer than the fourth section, and the fourth section is longer than the second section, the third section, and the fifth section.

5. The MEMS apparatus of claim 2, wherein the second section is longer than the third section, and the third section is longer than the fifth section.

6. The MEMS apparatus of claim 1, wherein the MEMS structure has two convex portions and three concave portions, and each of the two convex portions is located between two of the three concave portions.

7. The MEMS apparatus of claim 1, wherein when the driving frequency of the AC voltage in the bandwidth is applied to the input electrode to drive the MEMS structure, the MEMS structure is configured to form resonance vibrations of a first and a third in-plane flexural modes to trigger an internal resonance at a 1:6 frequency ratio.

8. The MEMS apparatus of claim 7, wherein the bandwidth corresponds to an energy transfer region between the first and third in-plane flexural modes of the MEMS structure.

9. The MEMS apparatus of claim 1, wherein the bandwidth is in a range from 1.338 MHz to 1.349 MHz.

10. The MEMS apparatus of claim 1, wherein the peaks of the frequency comb signal are top eight highest peaks of the frequency comb signal, and the processor is configured to define the amplitude range based on output power amplitudes of the top eight highest peaks of the frequency comb signal.

11. The MEMS apparatus of claim 10, wherein the processor is configured to divide the amplitude range into 2¹⁶ equal intervals to digitalize the amplitude of each of the top eight highest peaks of the frequency comb signal into a 16-bit stream.

12. The MEMS apparatus of claim 11, wherein the processor is configured to arrange the 16-bit streams of the top eight highest peaks in a horizontal direction to form a 128-bit physical unclonable function (PUF) key of the MEMS structure of the semiconductor device.

13. The MEMS apparatus of claim 12, comprising a plurality of the semiconductor devices, wherein the processor is configured to arrange the 128-bit PUF keys of the MEMS structures of the semiconductor devices in a vertical direction.

14. The MEMS apparatus of claim 1, wherein the power supply is configured to provide a bias DC voltage to the input electrode.

15. An operation method of a micro-electro-mechanical system (MEMS) apparatus, comprising:
providing at least one semiconductor device having a MEMS structure, an input electrode, and two anchors, wherein the two anchors of the MEMS structure are respectively fixed and serve as output electrodes, the input electrode is adjacent to a long side of the MEMS structure, and the MEMS structure comprises five sections having different widths;
generating an AC voltage to the input electrode by a lock-in amplifier;
backward sweeping frequencies of the AC voltage to form a signal drop within a bandwidth by the lock-in amplifier;
applying a driving frequency of the AC voltage in the bandwidth to the input electrode to drive the MEMS structure;
when applying the driving frequency of the AC voltage in the bandwidth to the input electrode to drive the MEMS structure, forming a frequency comb signal by a signal analyzer based on a beating waveform of the MEMS structure;
defining an amplitude range by a processor based on output power amplitudes of peaks of the frequency comb signal; and
digitalizing an amplitude of each of the peaks of the frequency comb signal by the processor based on the amplitude range.

16. The operation method of the MEMS apparatus of claim 15, further comprising:
when applying the driving frequency of the AC voltage in the bandwidth to the input electrode to drive the MEMS structure, forming resonance vibrations of a first and a third in-plane flexural modes of the MEMS structure to trigger an internal resonance at a 1:6 frequency ratio.

17. The operation method of the MEMS apparatus of claim 16, wherein backward sweeping frequencies of the AC voltage to form the signal drop within the bandwidth by the lock-in amplifier is performed such that the bandwidth corresponds to an energy transfer region between the first and third in-plane flexural modes of the MEMS structure.

18. The operation method of the MEMS apparatus of claim 15, further comprising:
selecting the peaks of the frequency comb signal to be top eight highest peaks of the frequency comb signal by the processor.

19. The operation method of the MEMS apparatus of claim 18, wherein defining the amplitude range by the processor based on the output power amplitudes of the peaks of the frequency comb signal comprises:
defining the amplitude range by the processor based on the output power amplitudes of the top eight highest peaks of the frequency comb signal.

20. The operation method of the MEMS apparatus of claim 19, wherein digitalizing the amplitude of each of the peaks of the frequency comb signal by the processor based on the amplitude range comprises:
dividing the amplitude range into 2¹⁶ equal intervals by the processor; and
digitalizing the amplitude of each of the top eight highest peaks of the frequency comb signal into a 16-bit stream by the processor.
